(19) United States
(12) Patent Application Publication
(10) Pub. No.: US 2025/0144505 A1
(43) Pub. Date: May 8, 2025

(54) CARD REUSE SYSTEM AND CARD REUSE METHOD

(71) Applicant: ANGEL GROUP CO., LTD., Shiga (JP)

(72) Inventor: Yasushi SHIGETA, Shiga (JP)

(21) Appl. No.: 18/940,587

(22) Filed: Nov. 7, 2024

(30) Foreign Application Priority Data
Nov. 8, 2023 (JP) 2023-190953

(51) Int. Cl. A63F 1/12

(52) U.S. Cl. CPC A63F 1/12

(57) ABSTRACT

A card reuse system comprises a plurality of card shooters, an extraction device that extracts a plurality of playing cards of a predetermined number of decks from a plurality of unused playing cards collected from the plurality of card shooters, and a card management system. The card management system comprises a collected card information acquisition unit that acquires collected card information, a collection inspection device that reads ranks and suits of actually collected playing cards, an non-extracted card information acquisition unit that acquires non-extracted card information on a playing card remaining after a new playing card package is formed, and a management device that determines whether the collected card information matches the ranks and suits inspected by the collection inspection device and determines whether the number of the formed new playing card packages and the non-extracted card information correspond to the collected card information.

### CROSS REFERENCE TO RELATED APPLICATION

The present application claims priority to JP Pat. App. 2023-190953 filed Nov. 8, 2023, the entire contents of which are hereby incorporated by reference.

### FIELD

The present disclosure relates to a card reuse system used, in a casino in which a plurality of game tables are installed, for collecting playing cards not used in the plurality of game tables and forming a new playing card set including playing cards of a predetermined number of decks, and a card reuse method used in the card reuse system.

### BACKGROUND

In a casino, a game using playing cards is played on a game table. Playing cards of a predetermined number of decks (for example, eight decks) are shuffled and packaged and provided in the game table. On the game table, a dealer opens the package and loads the shuffled playing cards into a card shooter. The dealer draws out the playing cards one by one from the card shooter and progresses a game.

When new shuffled playing cards are loaded into the card shooter, a cut card is inserted at a position slightly before the end of the shuffled playing cards. When the cut card is drawn out after executing a plurality of games, the dealer replaces the shuffled playing cards in the card shooter in a state where playing cards that have not been used remain in the card shooter. That is, the shuffled playing cards behind the cut card are discarded as unused (see, for example, JP 2015-181948 A).

Therefore, it is attempted to reuse these unused playing cards. A new shuffled playing card set can be formed by collecting these unused playing cards from a plurality of game tables and creating a set of playing cards of a predetermined number of decks.

However, playing cards are security items in casinos, and their management should be strict. If a player illegally acquires the playing cards, the player can perform a fraudulent act in a game using the illegally acquired playing cards.

### SUMMARY

Therefore, an object of the present invention is to provide a system capable of confirming whether any playing cards are missing due to loss, theft, or the like when playing cards remaining in card shooters without being used at a plurality of game tables are collected from the game tables and reused.

A card reuse system according to one aspect is a card reuse system that is used, in a casino in which a plurality of game tables are installed, for collecting playing cards not used in the plurality of game tables and taking the playing cards to a backyard, and forming, in the backyard, a new playing card set including the playing cards of a predetermined number of decks to be reused in the game tables, the card reuse system comprises: a plurality of card shooters used in the plurality of game tables, respectively, and for drawing out the playing cards one by one, wherein each of the plurality of card shooters is assigned shooter identification information to identify the card shooter and/or the playing card set loaded in the card shooter is assigned a set identification information; an extraction device that extracts a plurality of playing cards of a predetermined number of decks from a plurality of unused playing cards collected from the plurality of card shooters; a set formation device that forms the new playing card package with the plurality of playing cards of the predetermined number of decks extracted by the extraction device; and a card management system that manages formation of the new playing card set, the card management system comprises: a collected card information acquisition unit that acquires information on the number of cards of the plurality of playing cards collected from each of the plurality of card shooters, as well as the shooter identification information of the card shooter that collected the plurality of playing card and/or set identification information of the plurality of playing cards that were collected; and a management device that assigns set identification information for identifying the playing card set to the new playing card set newly formed by the set formation device, wherein the set formation device loads the new playing card set into a cartridge or a card package, and the cartridge is loaded into the card shooter or the playing card set in the card package is loaded into the card shooter, so that the new playing card set is used on the game table.

In the card reuse system, the management device may associate the set identification information of the new playing card set with the shooter identification information acquired by the card collected information acquisition unit, which is the shooter identification information of the plurality of card shooters that have collected the plurality of playing cards used to form the new playing card set, and/or the set identification information acquired by the collected card information acquisition unit, which is the set identification information of the plurality of playing cards used to form the new playing card set, or associates the set identification information of the new playing card set with the shooter identification information acquired by the card collected information acquisition unit, which is the shooter identification information of the plurality of card shooters that have collected the plurality of playing cards could have been used to form the new playing card set, and/or the set identification information acquired by the collected card information acquisition unit, which is the set identification information of the plurality of playing cards could have been used to form the new playing card set.

In the card reuse system, the card management system may further comprise: a collection inspection device that counts number of playing cards actually collected from the plurality of card shooters to the backyard; and a non-extracted card information acquisition unit that acquires information on the number of playing cards remaining among the plurality of playing cards collected from the plurality of card shooters and not extracted by the extraction device, and the management device may be configured to determine whether the number of cards obtained by the collected card information acquisition unit corresponds to the number of cards counted by the collection inspection device, and also determine whether the number of new playing card sets formed and the number of cards obtained by the non-extracted card information acquisition unit corresponds to the number of the playing cards acquired by the collected card information acquisition unit or the number of the playing cards counted by the collection inspection device.

In the card reuse system, the collected card information acquisition unit may further acquire rank and suit information of the plurality of playing cards collected from each of the plurality of card shooters, and the card management system may further comprise: a collected inspection device that reads rank and suit of the playing cards actually collected from the plurality of card shooters to the backyard; and a non-extracted card information acquisition unit that acquires rank and suit information of the playing cards remaining after the extraction device has extracted the playing cards collected from the plurality of card shooters, and the management device may be configured to determine whether the rank and suit information acquired by the collected card information acquisition unit corresponds to the rank and suit information read by the collected inspection device, and also determine whether the number of new playing card sets formed and the rank and suit information acquired by the non-extracted card information acquisition unit corresponds to the rank and suit information acquired by the collected card information acquisition unit or the rank and suit information read by the collected inspection device.

In the card reuse system, the extraction device is comprising: an extraction reading device that reads ranks and suits of a plurality of unused playing cards collected from the plurality of card shooters; and a distribution device that distributes playing cards constituting the plurality of playing cards of the predetermined number of decks and playing cards not constituting the plurality of playing cards of the predetermined number of decks on the basis of a result of reading by the extraction reading device.

In the card reuse system, the extraction reading device and the collection inspection device may be the same device.

In the card reuse system, each of the card shooter may comprises a drawn-out card inspection device that reads a rank and suit of a playing card being drawn out, and the collected card information acquisition unit may acquire information on ranks and suits of the plurality of playing cards collected from the card shooter on the basis of a result of inspection by the drawn-out card inspection device.

In the card reuse system, the collected card information acquisition unit may acquire information on the ranks and suits of the plurality of playing cards collected by reading the ranks and suits from the plurality of playing cards collected from the card shooter in the game table.

In the card reuse system, the game table may comprise a discard card inspection device that reads a rank and suit of a playing card that has been used and is to be discarded, and the collected card information acquisition unit may acquire information on ranks and suits of the plurality of playing cards collected from the card shooter on the basis of a result of inspection by the discard card inspection device.

In the card reuse system, the card reuse system may further comprise an identification number reading device that reads the set identification number in the game table, and the collected card information acquisition unit may acquire the set identification number of the playing card set read by the set identification number reading device together with information on the rank and suit of a plurality of collected playing cards.

In the card reuse system, the plurality of unused playing cards provided to the extraction device to constitute the plurality of playing cards of the predetermined number of decks may include playing cards that have not been extracted by the extraction device, which have not constituted the plurality of playing cards of the predetermined number of decks previously.

In the card reuse system, the extraction device is comprising a plurality of stages including a first stage and a second stage, and in the second stage, a plurality of playing cards of a predetermined number of decks may be extracted from the playing cards that have not been extracted in the first stage, which have not constituted the plurality of playing cards of the predetermined number of decks.

In the card reuse system, the non-extracted card information acquisition unit may acquire the information on the rank and suit of the remaining playing card on the basis of the information on the ranks and suits of the plurality of playing cards collected from each of the plurality of card shooters and the number of cards extracted by the extraction device.

In the card reuse system, the non-extracted card information acquisition unit may acquire the information on the rank and suit of the remaining playing card by reading the rank and suit of the playing card not extracted by the extraction device.

In the card reuse system, the information on the rank and suit may be encoded and written on the playing card.

In the card reuse system, on the playing card, the information on the rank and suit may be written with ink visualized by irradiation with ultraviolet rays or ink visualized by irradiation with infrared light.

In the card reuse system, the card shooter may comprise a drawn-out card inspection device that counts playing cards being drawn out, and the collected card information acquisition unit may acquire information on the number of a plurality of playing cards collected from the card shooter on the basis of a result of inspection by the drawn-out card inspection device.

In the card reuse system, the collected card information acquisition unit may acquire information on the number of the plurality of playing cards collected, by counting the plurality of playing cards collected from the card shooter in the game table.

In the card reuse system, the game table may comprise a discard card inspection device that counts playing cards that have been used and are to be discarded, and the collected card information acquisition unit may acquire information on the number of a plurality of playing cards collected from the card shooter on the basis of a result of inspection by the discard card inspection device.

In the card reuse system, the non-extracted card information acquisition unit may acquire information on the number of the remaining playing cards on the basis of information on the number of the plurality of playing cards collected from each of the plurality of card shooters and the number of cards extracted by the extraction device.

In the card reuse system, the non-extracted card information acquisition unit may acquire information on the number of the remaining playing cards by counting the number of the playing cards not extracted by the extraction device.

A card reuse method according to one aspect is a card reuse method in a casino in which a plurality of game tables is installed, is to collect playing cards not used in the plurality of game tables and taking the playing cards to a backyard, and to form, in the backyard, a new playing card set including playing cards of a predetermined number of decks to be reused in the game tables, wherein each of the plurality of card shooters is assigned a shooter identification information to identify the card shooter and/or the playing card set loaded in the card shooter is assigned a set identification information, a collection step of collecting the plurality of unused playing cards from the plurality of card shooters used at each of the plurality of gaming tables and for drawing out playing card one by one; an extraction step for extracting a plurality of playing cards of a predetermined number of decks from a plurality of unused playing cards collected in the collection step; a shuffling step for shuffling the predetermined number of playing cards extracted in the extraction step; a set formation step for forming the new playing card set with the predetermined number of playing cards shuffled in the shuffling step, a card management step for managing the formation of the new playing card set, and the card management step comprises: a collected card information acquisition step for acquiring information on the number of cards of the plurality of playing cards collected from each of the plurality of card shooters, as well as the shooter identification information of the card shooter that collected the plurality of playing cards and/or the set identification information of the plurality of playing cards that were collected, and a management step for assigning set identification information for identifying the playing card set to a new playing card set newly formed by the forming step, and wherein the set formation step is to load the new playing card set into a cartridge or card package, and the cartridge is loaded into the card shooter or the playing card set in the card package is loaded into the card shooter, so that the new playing card set is used on the game table.

The foregoing and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is a schematic diagram illustrating an overall configuration of a card reuse system according to an embodiment of the present invention;

FIG. 2 is a schematic diagram illustrating a configuration of a card shooter according to the embodiment of the present invention;

FIG. 3 is a schematic diagram illustrating a configuration of an extraction device according to the embodiment of the present invention;

FIG. 4 is a diagram illustrating an example of a data file including remaining card information according to the embodiment of the present invention;

FIG. 5 is a schematic diagram illustrating a configuration of a shuffle device according to the embodiment of the present invention;

FIG. 6 is a diagram illustrating an example of a data file of collected card information according to the embodiment of the present invention; and

FIG. 7 is a flowchart of the card reuse method of the embodiment of the present invention.

### DETAILED DESCRIPTION OF NON-LIMITING EXAMPLE EMBODIMENTS

Hereinafter, an embodiment of the present disclosure will be described with reference to the drawings. Note that the embodiment described below illustrates an example of a case where the present disclosure is implemented, and the present disclosure is not limited to the specific configuration described below. In carrying out the present disclosure, a specific configuration according to the embodiment may be appropriately adopted.

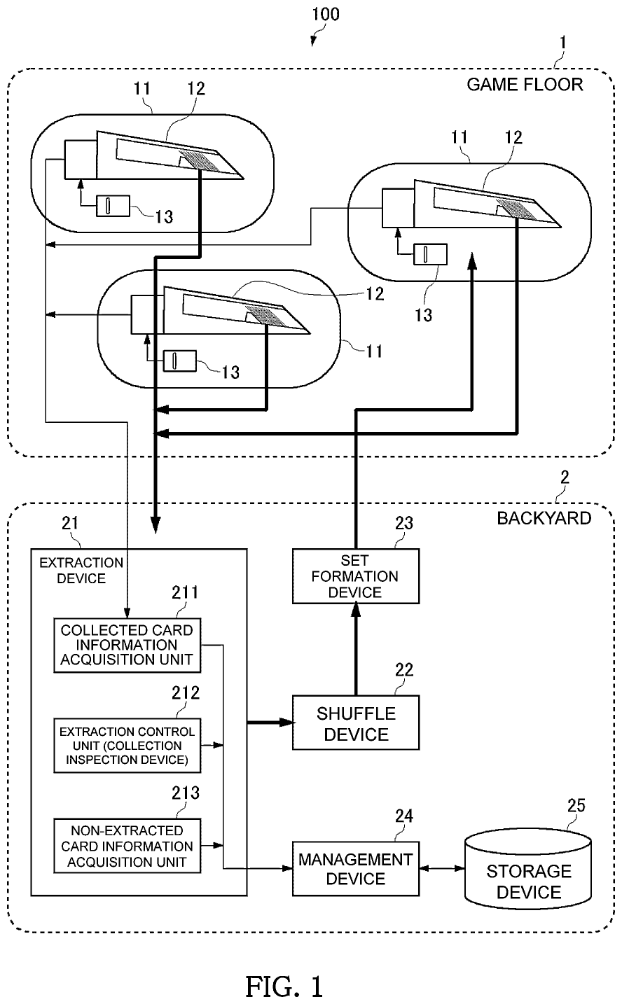

FIG. 1 is a schematic diagram illustrating an overall configuration of a card reuse system according to an embodiment of the present disclosure. In FIG. 1, thick line arrows indicate movement of playing cards, and thin line arrows indicate transmission of information. Note that the information may be transmitted in a wired or wireless manner.

As illustrated in FIG. 1, a card reuse system 100 is installed in a casino having a game floor 1 and a backyard 2. In the present embodiment, the backyard 2 is not limited to a general backyard as long as it is a space where security measures such as restriction of entry of a player are applied in order to form a new playing card package.

A plurality of game tables 11 are installed on the game floor 1. In the game tables 11, a plurality of respective card shooters 12 for drawing out shuffled playing cards one by one in a game are installed. A code reader 13 as a set identification information reading device for reading identification information attached to a set of shuffled playing cards is connected to each card shooter 12.

As described above, in each game table 11, even if some unused playing cards remain in the card shooter 12, the refresh operation of replacing the unused playing cards with new shuffled playing cards is performed with the drawing-out of a cut card from the card shooter 12 as a trigger. At this time, the remaining playing cards are removed from the card shooter 12. In the card shooter 12, the playing cards taken out in an unused state are collected and taken from the game table 11 to the backyard 2.

The playing cards used in a game are stored in a discard card box (not illustrated in FIG. 1) installed in the game table 11 every time the game is ended. The used playing cards accumulated in the discard card box are collected and taken to the backyard 2 at an appropriate timing and discarded through a predetermined route.

In the backyard 2, the unused playing cards collected from the plurality of game tables 11 are collected, playing cards constituting a predetermined number of decks (in the present embodiment, eight decks) are extracted, and shuffled to be packaged. In this way, the reproduced package of the shuffled playing cards is conveyed to the game table 11 again for reuse.

The backyard 2 comprises an extraction device 21 that extracts a plurality of playing cards of a predetermined number of decks from a plurality of unused playing cards collected from a plurality of card shooters 12 without being used in the game table 11, a shuffle device 22 that shuffles the plurality of playing cards of the predetermined number of decks extracted by the extraction device 21, and a set formation device 23 that forms a new playing card set with the plurality of playing cards of the predetermined number of decks shuffled by the shuffle device 22 and forms a playing card package by packaging the formed playing card set.

The extraction device 21 comprises a collected card information acquisition unit 211 that acquires information on the ranks and suits of the plurality of playing cards collected from each of the plurality of card shooters 12 and acquires information on the number of cards, a collection inspection device 212 that reads the ranks and suits of the playing cards actually collected from the card shooters 12 and taken to the backyard 2 and counts the number of cards, and a non-extracted card information acquisition unit 213 that acquires information on the ranks and suits of the playing cards that have not been extracted among the plurality of playing cards collected from the plurality of card shooters 12 and acquires information on the number of cards.

In addition, the backyard 2 comprises a management device 24 that manages formation of the playing card set and a storage device 25 that stores various data used in the management device 24. The management device 24 constitutes a card management system together with the collected card information acquisition unit 211, the collection inspection device 212, and the non-extracted card information acquisition unit 213. In this card management system, the management device 24 determines whether the information on the ranks and suits and the information on the number of cards acquired by the collected card information acquisition unit 211 corresponds to the ranks and suits, and the number of cards inspected by the collection inspection device 212. In addition, the management device 24 determines whether or not the number of formed new playing card sets and the information on the ranks and suits and the information on the number of cards acquired by the non-extracted card information acquisition unit 213 correspond to the information on the ranks and suits and the information on the number of cards acquired by the collected card information acquisition unit 211.

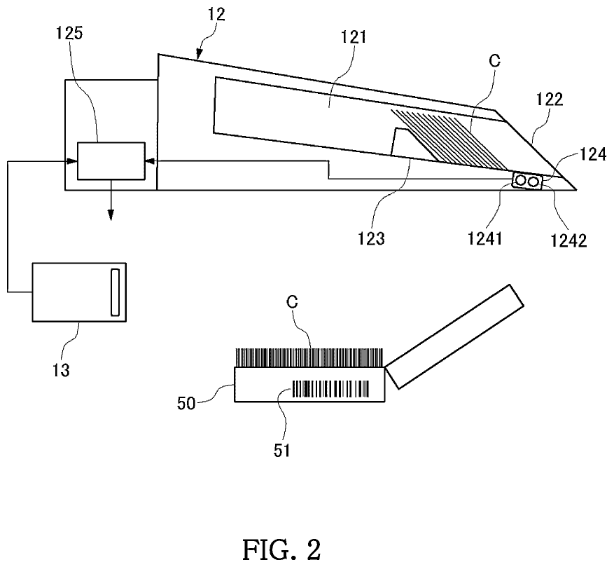

FIG. 2 is a schematic diagram illustrating a configuration of the card shooter according to the embodiment of the present disclosure. The card shooter 12 comprises a housing portion 121 for housing the shuffled playing cards C. The shuffled playing cards C housed in the housing portion 121 are drawn out one by one from a drawing-out port 122 and used for a game. A mouse 123 functioning as a weight for pressing the rear end playing card C toward the drawing-out port 122 is provided in the housing portion 121, and the head playing card C is always pressed against the drawing-out port 122 by the mouse 123.

A drawn-out card inspection device 124 that reads the ranks and suits of the playing cards C being drawn out and counts the number of the playing cards C is provided near the drawing-out port 122. The drawn-out card inspection device 124 comprises an ultraviolet lamp 1241 and a code detection sensor 1242. A binary code obtained by encoding the rank and suit is written on the surface (the surface on which the rank and suit are written) of each playing card C. This binary code is printed with ultraviolet light emitting ink that is not visible under natural light. The ultraviolet lamp 1241 irradiates the binary code of the playing card C being drawn out with ultraviolet light, and the code detection sensor 1242 scans the binary code illuminated by being irradiated with ultraviolet light, along the drawing direction of the playing card C.

Every time a playing card is drawn out, the drawn-out card inspection device 124 reads the rank and suit of the playing card, and sends the read information to a control device 125 as a remaining card inspection device. The control device 125 acquires information on the rank and suit of the read playing card from the drawn-out card inspection device 124, subtracts the information from that of the original shuffled playing cards (eight decks) to obtain the ranks and suits of the playing cards C remaining in the card shooter 12, and further obtains the number of remaining playing cards C.

FIG. 2 further illustrates a package 50 of shuffled playing cards. A barcode 51 representing identification information (package ID) of the package 50 is printed on the package 50. In addition, a code reader 13 for reading the barcode 51 of the package 50 is connected to the card shooter 12. The barcode 51 is read when the shuffled playing cards are newly loaded into the card shooter 12. The package ID, which is the identification information for the package, corresponds to the set identification information.

When unused playing cards C are taken out from the card shooter 12, the control device 125 outputs information on the ranks and suits of all the remaining playing cards at that time and information on the number of the remaining playing cards together with the set identification information of the playing cards.

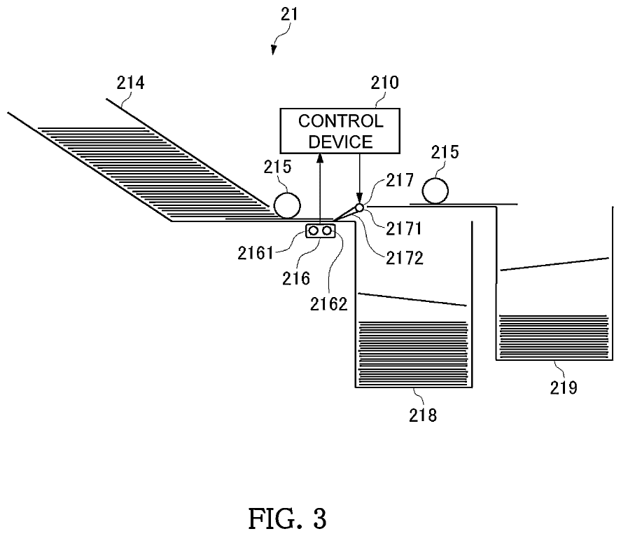

FIG. 3 is a schematic diagram illustrating a configuration of the extraction device according to the embodiment of the present disclosure. The extraction device 21 comprises a stocker 214 that stocks the playing cards C collected from the plurality of card shooters 12, a drawing-out roller 215 that draws out the playing cards C one by one from the stocker 214, an extraction reading device 216 that reads the binary codes of the ranks and suits of the playing cards C drawn out by the drawing-out roller 215, and a distribution device 217 that distributes the playing cards constituting the plurality of playing cards C of the predetermined number of decks and the playing cards not constituting the plurality of playing cards C of the predetermined number of decks on the basis of the result of reading by the extraction reading device 216.

The extraction reading device 216 has the same configuration as that of the drawn-out card inspection device 124 of the card shooter 12, and comprises an ultraviolet lamp 2161 and a code detection sensor 2162. The ultraviolet lamp 2161 irradiates the binary code on the surface of the playing card C conveyed by the drawing-out roller 215 with ultraviolet light, and the code detection sensor 2162 scans the binary code illuminated by the ultraviolet lamp 2161, along the conveying direction of the playing card C.

The distribution device 217 comprises a rotating shaft 2171 and a guide vane 2172. The guide vane 2172 is rotated by the rotation shaft 2171 to rotate between an extraction position and a non-extraction position. When the guide vane 2172 is at the extraction position (in the example of FIG. 3, the raised position), the playing card C conveyed by the drawing-out roller 215 is not guided by the guide vane 2172 and is sent to an extraction stocker 218 where the playing card is stocked to constitute the plurality of playing cards C of the predetermined number of decks. When the guide vane 2172 is at the non-extraction position (in the example of FIG. 3, a position where the leading end touches the playing card C to be conveyed), the playing card C conveyed by the drawing-out roller 215 is guided by the guide vane 2172 and sent to a non-extraction stocker 219 as the playing card C that is not used to constitute the playing cards C of the predetermined number of decks.

The extraction device 21 further comprises a control device 210 connected to the extraction reading device 216 and the distribution device 217. The control device 210 corresponds to the collected card information acquisition unit 211, the extraction control unit (collection inspection device) 212, and the non-extracted card information acquisition unit 213 illustrated in FIG. 1. An extraction control unit 214 controls the distribution device 217 on the basis of the result of reading by the extraction reading device 216 to distribute the playing card C to be extracted to constitute the plurality of playing cards of the predetermined number of decks, and the playing card C not to be extracted.

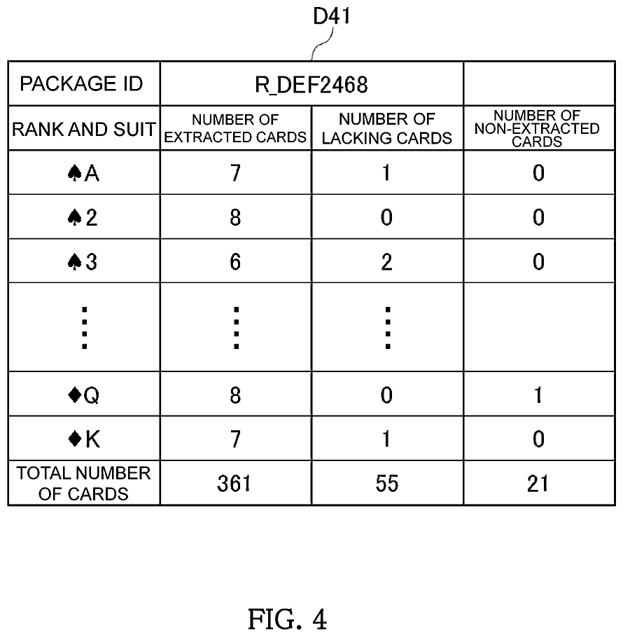

FIG. 4 is a diagram illustrating an example of a data file including non-extracted card information according to the embodiment of the present disclosure. The extraction control unit 214 updates a data file D41 on the basis of the result of reading by the extraction reading device 216. Specifically, for the rank and suit of the playing card C read by the extraction reading device 216, when the number of extracted cards does not reach eight, which is the predetermined number of decks, in the data file D41, the extraction control device 212 controls the distribution device 217 to convey the playing card C to the extraction stocker 218, and increases the number of the extracted cards by one and decreases the number of missing cards by one for the playing card C in the data file D41.

For the rank and suit of the playing card C read by the extraction reading device 216, when the number of extracted cards has reached eight, which is the predetermined number of decks, in the data file D41, the extraction control device 212 controls the distribution device 217 to convey the playing card C to the non-extraction stocker 219, and increases the number of non-extracted cards by one for the playing card C in the data file D41.

The extraction control unit 212 determines whether or not the number of extracted cards for every rank and suit is eight every time one playing card C is processed, and outputs a completion report when the number of extracted cards for every rank and suit becomes eight. At this time, a total of 416 playing cards C, eight playing cards C for every rank and suit, are stocked in the extraction stocker 218. The 416 playing cards are carried to the shuffle device 22. Note that the playing card C that has not been extracted by the extraction device 21 is returned to the stocker 214 again after the playing cards C of the predetermined number of decks are collected in the extraction stocker 218, so as to constitute the next playing cards of the predetermined number of decks.

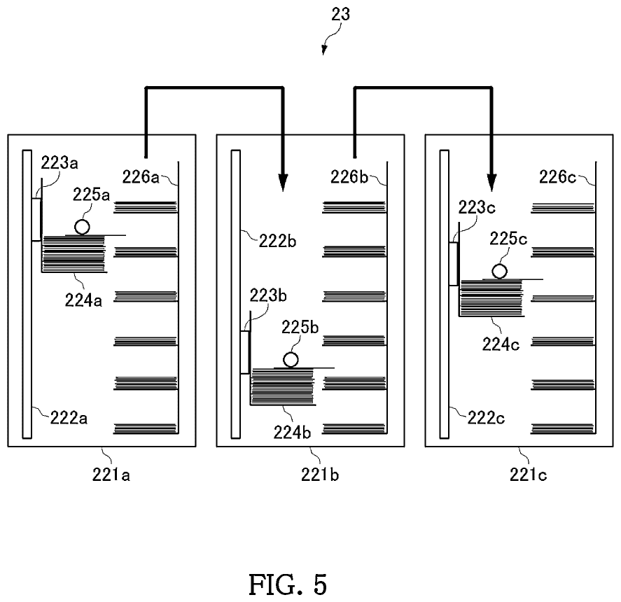

FIG. 5 is a schematic diagram illustrating a configuration of the shuffle device according to the embodiment of the present disclosure. The shuffle device 22 comprises a plurality of stages of sorting devices 221a to 221c. In the example of FIG. 5, the shuffle device 22 comprises the three-stage sorting devices 221a to 221c, but may comprise four or more stages. Since the sorting devices 221a to 221c in the plurality of stages have the same configuration, the sorting device 221a will be described below, and the description of the sorting devices 221b and 221c will be omitted.

The sorting device 221a comprises a rail 222a erected in the vertical direction, a slider 223a vertically movable along the rail 222a, a holder 224a fixed to the slider 223a and vertically moved together with the slider 223a, a sorting roller 225a for carrying out a plurality of playing cards C held by the holder 224a one by one, and a shelf 226a having a plurality of boxes for storing the playing cards C carried out from the holder 224 by the sorting roller 225a. In the example of FIG. 5, the shelf 226a comprises six boxes, but the number of boxes is not limited thereto.

The sorting device 221a further comprises a control device (not illustrated), and the slider 223a and the sorting roller 225a are driven under the control of the control device. The control device is given a random number and determines in which box of the shelf 226a a playing card is to be stored according to the random number.

A set of playing cards C of a predetermined number of decks (eight decks) extracted by the extraction device 21 is first loaded into the holder 224a of the first-stage sorting device 221a. When every playing card C is sorted into one of the boxes, the playing cards C sorted into the boxes are stacked in order from the top and loaded into the holder 224b of the second-stage sorting device 221b. By repeating this, the set of playing cards C of the predetermined number of decks (eight decks) is shuffled.

The playing cards C sorted into the plurality of boxes on the final stage of the shuffle device 22 are stacked in order from the top and carried to the set formation device 23. The set formation device 23 also functions as a packaging device that loads 416 shuffled playing cards C in a box, seals the box, and forms a package with a shrink film. The package including of set of the shuffled playing card C reproduced in this way is conveyed to the game table 11 again and used for a game.

The set formation device 23, as described above, forms a new playing card set from the predetermined number of playing cards shuffled by the shuffle device 22. At this time, the management device 24 assigns set identification information to the new playing card set formed by the set formation device 23 to identify the playing card set. The set formation device 23 also functions as a packaging device that loads the new playing card set into a card package. The playing card set of the card package is loaded into the card shooter 12, so that the new playing card set is used on the game table 11.

When the set identification information is assigned to the new playing card set in the set formation device 23, the management device 24 associates this set identification information with the set identification information of the plurality of playing cards used to form the new playing card set, which is acquired by the collected card information acquisition unit 211, and stores it in the storage device 25. To do this, the collection information acquisition unit 211 in the extraction device 21 outputs the set identification information of the playing card to the management device 24 each time an unused playing card from one card shooter 12 is supplied to the extraction device 21. The management device 24 accumulates the set identification information output from the extraction device 21 in this way until a new playing card set is completed, and when a new playing card set is formed by the set formation device 23, the management device 24 associates all the set identification information of unused playing cards that have been used to form the new playing card set with the set identification information of the new playing card set, and refreshes the accumulated set identification information.

As described above, the package of the new shuffled playing cards is formed using the playing cards C collected from the plurality of card shooters 12, but the card reuse system 100 of the present embodiment has a function of confirming whether any playing cards C are missing due to loss, theft, or the like between the collection of the playing cards C and the formation of the new package. Such confirmation is executed under the control of the management device 24.

First, the card reuse system 100 has a function of confirming whether the playing cards C collected from the card shooters 12 of the plurality of game tables 11 are certainly conveyed to the extraction device 21 of the backyard 2 without missing. Therefore, as described above, the control device 125 of the card shooter 12 outputs the information on the ranks and suits of the remaining playing cards collected without being used and the information on the number of the remaining playing cards together with the set identification information of the playing cards, and the collected card information acquisition unit 211 of the extraction device 21 acquires this information.

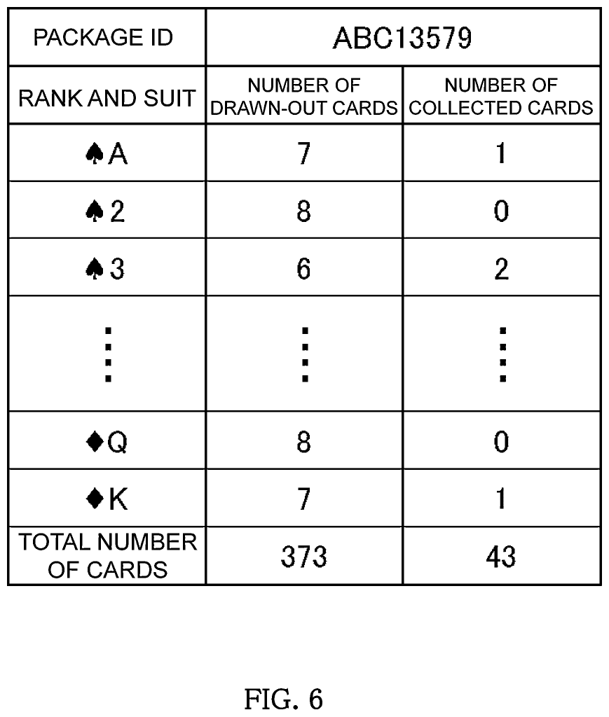

FIG. 6 is a diagram illustrating an example of a data file of collected card information according to the embodiment of the present disclosure. A data file D61 illustrated in FIG. 6 is provided from the card shooter 12 to the extraction device 21, and the extraction device 21 acquires the data file D61. The collected card information indicated by the data file D61 includes information on the number of cards for each rank and suit, and the total number of cards of the collected playing cards C. The extraction device 21 provides the acquired collected card information to the management device 24, and the storage device 25 stores the collected card information in association with its the set identification information.

In addition, as described above, the extraction control unit 212 of the extraction device 21 acquires the ranks and suits of the collected playing cards C one by one in order to determine the playing card to be extracted. The extraction control unit 212 outputs, as the collection inspection device, the number of cards for each rank and suit and the total number of cards, read by the extraction reading device 216, to the management device 24.

For this inspection, the playing cards C are held in the stocker 214 of the extraction device 21 for each card shooter 12 that has collected the unused playing cards C, that is, for each set identification information of the collected playing cards. The management device 24 inspects for each set identification information whether or not the collected card information corresponds to the information on the number of cards for each rank and suit and the total number of cards, input from the collection inspection device 212.

Further, when the playing cards C of the predetermined number of decks are extracted by the extraction device 21, the management device 24 checks whether the number of cards for each rank and suit of the plurality of playing cards C that have not been extracted is correct in light of the collected card information acquired by the collected card information acquisition unit 211. That is, the management device 24 inspects whether any playing cards C are missing when the extraction device 21 extracts the playing cards of the predetermined number of decks.

For example, when the playing cards of the predetermined number of decks are extracted from playing cards collected from 10 card shooters 12, the management device 24 checks whether the number of cards for each rank and suit obtained by subtracting the number of cards for each rank and suit (eight cards) of the predetermined number of decks (eight decks) from the sum of all the collected card information that is related to the 10 times of collection and is stored in the storage device 25 matches the number of cards for each rank and suit of the plurality of playing cards C that were determined to be not extracted by the extraction control unit 212.

In other words, the management device 24 inspects whether the number of cards for each rank and suit, which is obtained by adding the number of the extracted playing cards C for each rank and suit (eight cards) of the predetermined number of decks (eight decks) and the number of cards for each rank and suit of the plurality of playing cards C that have been determined not to be extracted, matches the total of the collected card information related to a plurality of times of collection by the collected card information acquisition unit 211.

As a result, it is inspected whether any playing cards are missing when the plurality of playing cards C collected by the plurality of times of collection are distributed for extracted/not extracted to constitute the playing cards C of the predetermined number of decks.

For this inspection, the non-extracted card information acquisition unit 213 acquires, as non-extracted card information, information on the number of cards for each rank and suit of the playing cards C determined not to be extracted on the basis of the determination of the extraction by the extraction control unit 212, and outputs the information to the management device 24.

When the playing cards C of the predetermined number of decks are extracted, the management device 24 inspects whether or not the collected card information input from the collected card information acquisition unit 211 corresponds to the non-extracted card information input from the non-extracted card information acquisition unit 213.

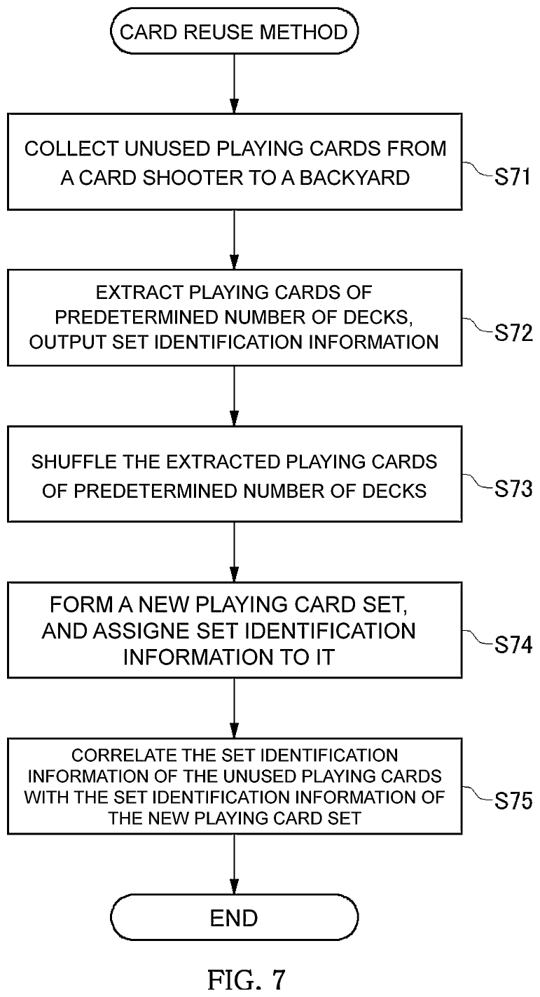

FIG. 7 is a flowchart of the card reuse method of the embodiment of the present disclosure. In the card reuse method, first, multiple unused playing cards are collected from the card shooter 12 to the backyard 2 (step S71). The extraction device 21 then extracts the predetermined number of playing cards from the plurality of unused playing cards that have been collected, and at this time, outputs the set identification information of the plurality of unused playing cards to the management device 24 (step S72). Next, the shuffle device 22 shuffles the predetermined number of playing cards that have been extracted by the extraction device 21 (step S73).

The set formation device 23 forms the new playing card set for the plurality of playing cards of the predetermined number of decks shuffled by the shuffle device 22, and assigns set identification information to the new playing card set (step S74). The management device 24 then associates the set identification information acquired from the collected card information acquisition unit 211 with the set identification information assigned to the new playing card set by the set formation device 23 and stores it in the storage device 25 (step S75).

In the above embodiment, the non-extracted card information acquisition unit 213 acquires the information on the ranks and suits of the playing cards C determined not to be extracted by the extraction control device 212 as the non-extracted card information. Alternatively, the non-extracted card information acquisition unit 213 may acquire the non-extracted card information by reading the ranks and suits of the plurality of playing cards C stocked in the non-extraction stocker 219.

In the above embodiment, the management device 24 inspects whether the collected card information corresponds to the non-extracted card information when the playing cards C of the predetermined number of decks are extracted. Alternatively, the management device 24 may inspect for each collection (that is, for each set identification information) whether the total of the number of cards for each rank and suit of the playing cards C that have been extracted and the number of cards for each rank and suit of the playing cards C that have not been extracted by the extraction device 21 corresponds to the collected card information.

In the above embodiment, the management device 24 determines whether the information on the number of cards for each rank and suit obtained by the collected card information acquisition unit 211 matches the number of cards of each rank and suit inspected by the collection inspection device 212, and also determines whether the number of the new playing card sets formed and the number of cards of each rank and suit acquired by the non-extracted card information acquisition unit 213 correspond to the number of cards of each rank and suit acquired by the collected card information acquisition unit 211. Alternatively, the management device 24 may only determine whether the total number of cards matches or corresponds. In other words, the management device 24 may determine whether the total number of cards obtained by the collection card information acquisition device 211 matches the information on the total number of cards inspected by the collection inspection device 212, and also determine whether the number of new playing card sets formed corresponds to the total number of cards obtained by the collected card information acquisition unit 213.

In the above embodiment, the management device 24 checks whether any playing cards C are missing between the collection and the reproduction by inspecting the ranks and suits of the playing cards C and the total number of the playing cards C. However, the management device 24 may check whether any playing cards C are missing by inspecting the ranks and suits of the playing cards C, or the management device 24 may check whether any playing cards C are missing by inspecting only the number of playing cards C.

In the above embodiment, the information on the suits and ranks and on the number of cards of the remaining (collected) playing cards is acquired as the collected card information by subtracting, from the original shuffled playing card, the result of reading the cards drawn out one by one at the card shooter 12. Alternatively, the collected card information may be acquired by a collected card reading device that reads the collected playing cards or a discard card reading device that reads discard cards that have been used for a game and are to be discarded.

The collected card reading device reads the ranks and suits of the playing cards, with the same configuration as the drawn-out card inspection device 124 while conveying the collected playing cards one by one. Note that the card shooter 12 may be used as the collected card reading device. In this case, the card shooter 12 is set to a collected card reading mode, and the playing cards to be collected are drawn out one by one, so that the ranks and suits are read by the drawn-out card inspection device 124.

In the case of reading discard cards, a discard inlet is provided in the game table 11, and the rank and suit of a playing card inserted into the discard inlet after being used in a game are read by the same configuration as that of the drawn-out card inspection device 124.

In the above embodiment, the information on the rank and suit is printed on the playing card in the form of a binary code with ultraviolet emitting ink, but instead of ultraviolet emitting ink, the information may be printed with ultraviolet absorbing ink visualized by irradiation with infrared light. In addition, instead of printing with such invisible ink, the marks of the rank and suit printed on a playing card may be photographed, and the rank and suit may be read by image analysis.

In the above embodiment, the management device 24 determines whether or not the number of formed new playing card set and the information on the ranks and suits and the information on the number of cards acquired by the non-extracted card information acquisition unit 213 correspond to the information on the ranks and suits and the information on the number of cards acquired by the collected card information acquisition unit 211. Alternatively, the management device 24 may determine whether the number of formed new playing card set and the information on the ranks and suits and the information on the number of cards acquired by the non-extracted card information acquisition unit 213 correspond to the information on the ranks and suits and the information on the number of cards inspected by the collection inspection device 212.

In the above embodiment, the plurality of playing cards of the predetermined number of decks extracted by the extraction device 21 are shuffled by the shuffle device 22 and then packaged by the packaging device 23, but shuffling by the shuffle device may be omitted. That is, since the collected unused playing cards are already shuffled, it is considered that the randomness of the order of the playing cards is not lost even in a state where such unused playing cards are collected from the plurality of card shooters 12 and sets of a plurality of playing cards of a new predetermined number of decks are extracted. Therefore, the shuffle device 22 may be omitted.

Further, in the above embodiment, the card management system has a function of confirming whether any playing cards are not lost before the unused playing cards are collected and reused. However, in the present specification, a card reuse system not having such a function is also disclosed as the disclosure.

In addition, in the above embodiment, in order to inspect whether the ranks and suits, and the number of playing cards actually collected and taken to the backyard matches the collected card information, a configuration is used in which the ranks and suits are read in order to extract playing cards of a predetermined number of decks by the extraction device 21. However, instead of this, a collection inspection device that inspects whether the ranks and suits, and the number of playing cards actually collected and taken to the backyard matches the collected card information, may be provided in the backyard separately from the extraction device 21.

In the above embodiment, the extraction device 21 is configured to extract only one set of the plurality of playing cards of the predetermined number of decks, but instead of this, the extraction device 21 may be configured to have a plurality of stages including the first stage and the second stage. In this case, in the second stage, the plurality of playing cards of the predetermined number of decks are extracted from the playing cards that have not been extracted in the first stage, which have not constituted the plurality of playing cards of the predetermined number of decks.

In the above embodiment, the extraction process is performed in the extraction device 21 for each set of the plurality of playing cards collected from one card shooter 12, but the extraction process may be performed by simultaneously putting the plurality of playing cards collected from the plurality of card shooters 12 into the stocker 214. In addition, a plurality of playing cards newly collected from the card shooter 12 may be added to the stocker 214 while the extraction device 21 is performing the extraction process.

Further, the extraction device 21 may have a function of inspecting the quality of the playing cards in the process of processing the playing cards one by one, and may be configured not to extract the playing card whose quality does not satisfy a predetermined criterion. The quality of the playing cards inspected here may be, for example, the presence or absence of a break, the presence or absence of a scratch, and the presence or absence of oil stain (by a finger).

In addition, in the above embodiment, the non-extracted card information acquisition unit 213 acquires the information on the ranks and suits and the information on the number of cards of the non-extracted playing cards by the calculation of subtracting the ranks and suits extracted from the ranks and suits of the collected playing cards. Alternatively, the information on the ranks and suits and the information on the number of cards of the non-extracted playing cards may be acquired by using a device that reads the ranks and suits of the non-extracted playing cards.

In the above embodiment, a new playing card set is provided to the card shooter 12 in the form of a package, and the package is opened and the playing card set is loaded into the card shooter 12. Alternatively, the card shooter 12 may adopt a cartridge system. In this case, the storage unit 121 of the card shooter 12 is detachable from the card shooter 12 as a cartridge, and the cartridge is replaced when refreshing. For this reason, a new playing card set is provided to the game table 11 in a state where it is housed in a cartridge, and when refreshing, the cartridge that housed the new playing card set is attached to the card shooter 12 in place of the cartridge that is previously attached to the card shooter 12.

The cartridge is provided with a locking mechanism to prevent playing cards from being removed or added during transport. The cartridge is unlocked by the locking mechanism when it is attached to the card shooter 12. A cartridge is used when unused playing cards are conveyed to the extraction device 21 in the backyard 2, in this case too, the lock mechanism locks it during conveyance. The set formation device 23 loads the newly formed playing card set into the cartridge instead of packaging, and locks lock mechanism of the cartridge.

In the same way that the set identification information is printed on the package, this cartridge is also given set identification information. In order to enable the cartridge to be used repeatedly, the set identification information is given to the cartridge in a rewritable format. For example, a piece of paper with the set identification information printed on is attached to the cartridge.

In the above embodiment, when unused playing cards are collected from the card shooter 12, the set identification information of the unused playing cards is provided from the card shooter 12 to the extraction device 21. Alternatively, or in addition to this, the shooter identification information for identifying the card shooter 12 may be provided from the card shooter 12 to the extraction device 21.

In this case, the management device 24 associates the set identification information acquired by the collected card information acquisition unit 211, which is the set identification information for the plurality of playing cards used to form a new playing card set, instead of or in addition, the shooter identification information acquired by the collected card information acquisition unit 211, which is the shooter identification information of the plurality of card shooters collected the plurality of playing cards used to form the new playing card set, with the set identification information of the new playing card set, and stores in the storage device 25.

In the above embodiment, the management device 24 associates the set identification information of the new playing card set with the set identification information acquired by the collected card information acquisition unit 211, which is the set identification information of the plurality of playing cards used to form the new playing card set. Alternatively, or in addition to this, the set identification information of the new playing card set may be associated with the set identification information of the plurality of playing cards that could have been used to form the new playing card set, which is acquired by the collected card information acquisition unit 211.

In other words, in the above embodiment, the plurality of unused playing cards collected from one card shooter 12 are supplied to the extraction device 21 as a group, and at that time, the set identification information of the plurality of unused playing cards is reported to the management device 24 from the extraction device 21, and the management device 24 accumulates the set identification information of the unused playing cards used for that until a new playing card set is formed by the set formation device 23, and when a new playing card set is formed by the set formation device 23, it associates all of the set identification information that has been accumulated up to that point with the set identification information of the newly formed playing card set. Alternatively, a less strict management method may be used.

In other words, without strictly managing the set identification information of unused playing cards supplied to the extraction device 21, the management device 24 may associate the set identification information of unused playing cards supplied to the extraction device 21 with the set identification information of new playing card sets formed by the set formation device 23 during a certain period (e.g., one day). Alternatively, the management device 24 may associate the set identification information of unused playing cards collected in the backyard 2 during a certain period of time with the set identification information of new playing card sets formed by the set formation device 23 during a certain period of time. In other words, the unused playing cards with the set identification information associated with the set identification information of the new playing card set formed by the set formation device 23 may not necessarily be included in the new playing card set. Or, the new playing card set with the set identification information associated with the set identification information of the unused playing cards may not necessarily include the unused playing cards.

The management device 24 may also associate the set identification information of the new playing card set with the shooter identification information acquired by the card shooter information acquisition unit 211, which is the shooter identification information of the plurality of card shooters 12 that have collected the plurality of playing cards that could have been used to form the new playing card set.

The following disclosures are also disclosed in this specification.

A card reuse system according to one aspect is a card reuse system that is used, in a casino in which a plurality of game tables are installed, for collecting playing cards not used in the plurality of game tables and taking the playing cards to a backyard, and forming, in the backyard, a new playing card package including playing cards of a predetermined number of decks to be reused in the game tables, the card reuse system comprising: a plurality of card shooters used in the plurality of game tables, respectively, and for drawing out the playing cards one by one; an extraction device that extracts a plurality of playing cards of a predetermined number of decks from a plurality of unused playing cards collected from the plurality of card shooters; and a packaging device that forms the new playing card package with the plurality of playing cards of the predetermined number of decks extracted by the extraction device, and a card management system that manages formation of the new playing card package. The card management system comprises: a collected card information acquisition unit that acquires at least information on ranks and suits of a plurality of playing cards collected from each of the plurality of card shooters; a collection inspection device that reads ranks and suits of playing cards actually collected from the card shooter and taken to the backyard; a non-extracted card information acquisition unit that acquires information on a rank and suit of a playing card remaining without being extracted by the extraction device among the plurality of playing cards collected from the plurality of card shooters; and a management device that determines whether the information on the ranks and suits acquired by the collected card information acquisition unit corresponds to the ranks and suits inspected by the collection inspection device, and determines whether or not the number of the new playing card packages formed and the information on the rank and suit acquired by the non-extracted card information acquisition unit correspond to the information on the ranks and suits acquired by the collected card information acquisition unit or the information on the ranks and suits inspected by the collection inspection device.

The card reuse system may further comprise a shuffle device that shuffles the plurality of playing cards of the predetermined number of decks extracted by the extraction device, and the packaging device may form the new playing card package with the plurality of playing cards of the predetermined number of decks shuffled by the shuffle device.

In the card reuse system, the extraction device comprises an extraction reading device that reads ranks and suits of a plurality of unused playing cards collected from the plurality of card shooters, and a distribution device that distributes playing cards constituting the plurality of playing cards of the predetermined number of decks and playing cards not constituting the plurality of playing cards of the predetermined number of decks on the basis of a result of reading by the extraction reading device.

In the card reuse system, the extraction reading device and the collection inspection device may be the same device.

In the card reuse system, each of the card shooters may comprise a drawn-out card inspection device that reads a rank and suit of a playing card being drawn out, and the collected card information acquisition unit may acquire information on ranks and suits of a plurality of playing cards collected from the card shooter on the basis of a result of inspection by the drawn-out card inspection device.

In the card reuse system, the collected card information acquisition unit may acquire information on the ranks and suits of the plurality of playing cards collected by reading the ranks and suits from the plurality of playing cards collected from the card shooter in the game table.

In the card reuse system, the game table may comprise a discard card inspection device that reads a rank and suit of a playing card that has been used and is to be discarded, and the collected card information acquisition unit may acquire information on ranks and suits of a plurality of playing cards collected from the card shooter on the basis of a result of inspection by the discard card inspection device.

In the card reuse system, the playing card package may have an identification number, an identification number reading device that reads the identification number may be comprised in the game table, and the collected card information acquisition unit may acquire the identification number of the playing card package read by the identification number reading device together with information on ranks and suits of a plurality of collected playing cards.

In the card reuse system, the plurality of unused playing cards provided to the extraction device to constitute the plurality of playing cards of the predetermined number of decks may include playing cards that have not been extracted by the extraction device, which have not constituted the plurality of playing cards of the predetermined number of decks previously.

In the card reuse system, the extraction device comprises a plurality of stages including a first stage and a second stage, and in the second stage, a plurality of playing cards of a predetermined number of decks may be extracted from the playing cards that have not been extracted in the first stage, which have not constituted the plurality of playing cards of the predetermined number of decks.

In the card reuse system, the non-extracted card information acquisition unit may acquire the information on the rank and suit of the non-extracted playing card on the basis of the information on the ranks and suits of the plurality of playing cards collected from each of the plurality of card shooters and the number of cards extracted by the extraction device.

In the card reuse system, the non-extracted card information acquisition unit may acquire the information on the rank and suit of the non-extracted playing card by reading the rank and suit of the playing card not extracted by the extraction device.

In the card reuse system, the information on the rank and suit may be encoded and written on the playing card.

In the card reuse system, on the playing card, the information on the rank and suit may be written with ink visualized by irradiation with ultraviolet rays or ink visualized by irradiation with infrared light.

A card reuse system according to another aspect is a card reuse system that is used, in a casino in which a plurality of game tables are installed, for collecting playing cards not used in the plurality of game tables and taking the playing cards to a backyard, and forming, in the backyard, a new playing card package including playing cards of a predetermined number of decks to be reused in the game tables, the card reuse system comprising: a plurality of card shooters used in the plurality of game tables, respectively, and for drawing out the playing cards one by one; an extraction device that extracts a plurality of playing cards of a predetermined number of decks from a plurality of unused playing cards collected from the plurality of card shooters; and a packaging device that forms the new playing card package with the plurality of playing cards of the predetermined number of decks extracted by the extraction device, and a card management system that manages formation of the new playing card package. The card management system comprises: a collected card information acquisition unit that acquires at least information on the number of a plurality of playing cards collected from each of the plurality of card shooters; a collection inspection device that counts the number of playing cards actually collected from the card shooter and taken to the backyard; a non-extracted card information acquisition unit that acquires information on the number of playing cards remaining without being extracted by the extraction device among the plurality of playing cards collected from the plurality of card shooters; and a management device that determines whether the information on the number of playing cards acquired by the collected card information acquisition unit corresponds to the number of playing cards counted by the collection inspection device, and determines whether or not the number of the new playing card packages formed and the information on the number of playing cards acquired by the non-extracted card information acquisition unit correspond to the information on the number of playing cards acquired by the collected card information acquisition unit or the information on the number of playing cards inspected by the collection inspection device.

In the card reuse system, the extraction device comprises an extraction reading device that reads ranks and suits of a plurality of unused playing cards collected from the plurality of card shooters, and a distribution device that distributes playing cards constituting the plurality of playing cards of the predetermined number of decks and playing cards not constituting the plurality of playing cards of the predetermined number of decks on the basis of a result of reading by the extraction reading device.

In the card reuse system, the extraction reading device and the collection inspection device may be the same device.

In the card reuse system, each of the card shooters may comprise a drawn-out card inspection device that counts playing cards being drawn out, and the collected card information acquisition unit may acquire information on the number of a plurality of playing cards collected from the card shooter on the basis of a result of inspection by the drawn-out card inspection device.

In the card reuse system, the collected card information acquisition unit may acquire information on the number of the plurality of playing cards collected, by counting the plurality of playing cards collected from the card shooter in the game table.

In the card reuse system, the game table may comprise a discard card inspection device that counts playing cards that have been used and are to be discarded, and the collected card information acquisition unit may acquire information on the number of a plurality of playing cards collected from the card shooter on the basis of a result of inspection by the discard card inspection device.

In the card reuse system, the playing card package may have an identification number, an identification number reading device that reads the identification number may be comprised in the game table, and the collected card information acquisition unit may acquire the identification number of the playing card package read by the identification number reading device together with information on the number of the plurality of collected playing cards.

In the card reuse system, the plurality of unused playing cards provided to the extraction device to constitute the plurality of playing cards of the predetermined number of decks may include playing cards that have not been extracted by the extraction device, which have not constituted the plurality of playing cards of the predetermined number of decks previously.

In the card reuse system, the extraction device comprises a plurality of stages including a first stage and a second stage, and in the second stage, a plurality of playing cards of a predetermined number of decks may be extracted from the playing cards that have not been extracted in the first stage, which have not constituted the plurality of playing cards of the predetermined number of decks.

In the card reuse system, the non-extracted card information acquisition unit may acquire information on the number of the non-extracted playing cards on the basis of information on the number of the plurality of playing cards collected from each of the plurality of card shooters and the number of cards extracted by the extraction device.

In the card reuse system, the non-extracted card information acquisition unit may acquire information on the number of the non-extracted playing cards by counting the number of the playing cards not extracted by the extraction device.

A card management system according to one aspect is a card management system that is used, in a casino in which a plurality of game tables each including a card shooter for drawing out playing cards one by one are installed, for collecting playing cards not used in the plurality of game tables and taking the playing cards to a backyard, and forming, in the backyard, a new playing card package including playing cards of a predetermined number of decks to be reused in the game tables, the card management system comprising: a collected card information acquisition unit that acquires at least information on ranks and suits of a plurality of playing cards collected from each of the plurality of card shooters; a collection inspection device that reads ranks and suits of playing cards actually collected from the card shooter and taken to the backyard; a non-extracted card information acquisition unit that acquires information on a rank and suit of a playing card remaining without being extracted to form the new playing card package, among the plurality of playing cards collected from the plurality of card shooters; and a management device that determines whether the information on the ranks and suits acquired by the collected card information acquisition unit corresponds to the ranks and suits read by the collection inspection device, and determines whether or not the number of the new playing card packages formed and the information on the rank and suit acquired by the non-extracted card information acquisition unit correspond to the information on the ranks and suits acquired by the collected card information acquisition unit or the information on the ranks and suits inspected by the collection inspection device.

A card management system according to another aspect is a card management system that is used, in a casino in which a plurality of game tables each including a card shooter for drawing out playing cards one by one are installed, for collecting playing cards not used in the plurality of game tables and taking the playing cards to a backyard, and forming, in the backyard, a new playing card package including playing cards of a predetermined number of decks to be reused in the game tables, the card management system comprising: a collected card information acquisition unit that acquires at least information on the number of a plurality of playing cards collected from each of the plurality of card shooters; a collection inspection device that counts the number of playing cards actually collected from the card shooter and taken to the backyard; a non-extracted card information acquisition unit that acquires information on the number of a playing card remaining without being extracted to form the new playing card package, among the plurality of playing cards collected from the plurality of card shooters; and a management device that determines whether the information on the number of cards acquired by the collected card information acquisition unit corresponds to the number of cards read by the collection inspection device, and determines whether or not the number of the new playing card packages formed and the information on the number of cards acquired by the non-extracted card information acquisition unit correspond to the information on the number of cards acquired by the collected card information acquisition unit or the information on the number of cards inspected by the collection inspection device.

1. A card reuse system that is used in a casino in which a plurality of game tables are installed, for collecting playing cards not used in the plurality of game tables and taking the playing cards to a backyard, and forming, in the backyard, a new playing card set including the playing cards of a predetermined number of decks to be reused in the game tables, the card reuse system comprises:
a plurality of card shooters configured to be used in the plurality of game tables, respectively, and for drawing out the playing cards one by one, wherein each of the plurality of card shooters is assigned shooter identification information to identify the card shooter and/or the playing card set to be loaded in the card shooter is assigned a set identification information;
an extraction device configured to extract a plurality of playing cards of a predetermined number of decks from a plurality of unused playing cards collected from the plurality of card shooters;
a set formation device configured to form the new playing card set with the plurality of playing cards of the predetermined number of decks extracted by the extraction device; and
a card management system configured to manage formation of the new playing card set, the card management system comprises:
a collected card information acquisition unit configured to acquire information on the number of cards of the plurality of playing cards collected from each of the plurality of card shooters, as well as the shooter identification information of the card shooter that collected the plurality of playing card and/or set identification information of the plurality of playing cards that were collected; and
a management device configured to assign set identification information for identifying the playing card set to the new playing card set newly formed by the set formation device,
wherein the set formation device is configured to load the new playing card set into a cartridge or a card package, and the cartridge is loaded into the card shooter or the playing card set in the card package is loaded into the card shooter, so that the new playing card set is used on the game table.

2. The card reuse system according to claim 1, wherein the management device is configured to associate the set identification information of the new playing card set with the shooter identification information acquired by the card collected information acquisition unit, which is the shooter identification information of the plurality of card shooters that have collected the plurality of playing cards used to form the new playing card set, and/or the set identification information acquired by the collected card information acquisition unit, which is the set identification information of the plurality of playing cards used to form the new playing card set, or is configured to associate the set identification information of the new playing card set with the shooter identification information acquired by the card collected information acquisition unit, which is the shooter identification information of the plurality of card shooters that have collected the plurality of playing cards could have been used to form the new playing card set, and/or the set identification information acquired by the collected card information acquisition unit, which is the set identification information of the plurality of playing cards could have been used to form the new playing card set.

3. The card reuse system according to claim 1, wherein the card management system further comprises:
a collection inspection device configured to count number of playing cards actually collected from the plurality of card shooters to the backyard; and
a non-extracted card information acquisition unit configured to acquire information on number of playing cards remaining among the plurality of playing cards collected from the plurality of card shooters and not extracted by the extraction device,
wherein the management device is configured to determine whether the number of cards obtained by the collected card information acquisition unit matches the number of cards counted by the collection inspection device, and also configured to determine whether the number of new playing card sets formed and the number of cards obtained by the non-extracted card information acquisition unit corresponds to the number of the playing cards acquired by the collected card information acquisition unit or the number of the playing cards counted by the collection inspection device.

4. The card reuse system according to claim 1, wherein the collected card information acquisition unit is further configured to acquire rank and suit information of the plurality of playing cards collected from each of the plurality of card shooters, the card management system further comprises:
a collected inspection device configured to read rank and suit of the playing cards actually collected from the plurality of card shooters to the backyard; and
a non-extracted card information acquisition unit configured to acquire rank and suit information of the playing cards remaining after the extraction device has extracted the playing cards collected from the plurality of card shooters,
wherein the management device is configured to determine whether the rank and suit information acquired by the collected card information acquisition unit matches the rank and suit information read by the collected inspection device, and also determine whether the number of new playing card sets formed and the rank and suit information acquired by the non-extracted card information acquisition unit corresponds to the rank and suit information acquired by the collected card information acquisition unit or the rank and suit information read by the collected inspection device.

5. The card reuse system according to claim 1, wherein the extraction device comprises:
an extraction reading device configured to read ranks and suits of a plurality of unused playing cards collected from the plurality of card shooters; and
a distribution device configured to distribute playing cards constituting the plurality of playing cards of the predetermined number of decks and playing cards not constituting the plurality of playing cards of the predetermined number of decks on the basis of a result of reading by the extraction reading device.

6. The card reuse system according to claim 5, wherein the extraction reading device and the collected inspection device are the same device.

7. The card reuse system according to claim 4, wherein the card shooter comprises a drawn-out card inspection device configured to read a rank and suit of a playing card being drawn out, and
the collected card information acquisition unit is configured to acquire information on ranks and suits of the plurality of playing cards collected from the card shooter on the basis of a result of inspection by the drawn-out card inspection device.

8. The card reuse system according to claim 1, wherein the collected card information acquisition unit is configured to acquire information on the ranks and suits of the plurality of playing cards collected by reading the ranks and suits from the plurality of playing cards collected from the card shooter on the game table.

9. The card reuse system according to claim 4, wherein the game table comprises a discard card inspection device configured to read a rank and suit of a playing card that has been used and is to be discarded, and
the collected card information acquisition unit is configured to acquire information on ranks and suits of the plurality of playing cards collected from the card shooter on the basis of a result of inspection by the discard card inspection device.

10. The card reuse system according to claim 1, further comprising an identification information reading device that reads the set identification information in the gaming table,
wherein the collected card information acquisition unit is configured to acquire the set identification number of the playing card set read by the set identification information reading device together with information on the rank and suit of a plurality of collected playing cards.

11. The card reuse system according to claim 1, wherein the plurality of unused playing cards provided to the extraction device to constitute the plurality of playing cards of the predetermined number of decks include playing cards that have not been extracted by the extraction device, which have not constituted the plurality of playing cards of the predetermined number of decks previously.

12. The card reuse system according to claim 1, wherein the extraction device is comprising a plurality of stages including a first stage and a second stage, and in the second stage, a plurality of playing cards of a predetermined number of decks are extracted from the playing cards that have not been extracted in the first stage, which have not constituted the plurality of playing cards of the predetermined number of decks.

13. The card reuse system according to claim 4, wherein the non-extracted card information acquisition unit is configured to acquire the information on the rank and suit of the non-extracted playing card on the basis of the information on the ranks and suits of the plurality of playing cards collected from each of the plurality of card shooters and the number of cards extracted by the extraction device.

14. The card reuse system according to claim 4, wherein the non-extracted card information acquisition unit is configured to acquire the information on the rank and suit of the non-extracted playing card by reading the rank and suit of the playing card not extracted by the extraction device.

15. The card reuse system according to claim 4, the information on the rank and suit is encoded and written on the playing card.

16. The card reuse system according to claim 4, on the playing card, the information on the rank and suit is written with ink visualized by irradiation with ultraviolet rays or ink visualized by irradiation with infrared light.

17. The card reuse system according to claim 1, wherein the card shooter comprises a drawn-out card inspection device configured to count playing cards being drawn out, and
the collected card information acquisition unit is configured to acquire information on the number of the plurality of playing cards collected from the card shooter on the basis of a result of inspection by the drawn-out card inspection device.

18. The card reuse system according to claim 1, wherein the collected card information acquisition unit is configured to acquire information on the number of the plurality of playing cards collected, by counting the plurality of playing cards collected from the card shooter on the game table.

19. The card reuse system according to claim 1, wherein the game table comprises a discard card inspection device configured to count playing cards that have been used and are to be discarded, and
the collected card information acquisition unit is configured to acquire information on the number of the plurality of playing cards collected from the card shooter on the basis of a result of inspection by the discard card inspection device.

20. The card reuse system according to claim 3, wherein the non-extracted card information acquisition unit is configured to acquire information on the number of the non-extracted playing cards on the basis of information on the number of the plurality of playing cards collected from each of the plurality of card shooters and the number of cards extracted by the extraction device.

21. The card reuse system according to claim 3, wherein the non-extracted card information acquisition unit is configured to acquire information on the number of the non-extracted playing cards by counting the number of the playing cards not extracted by the extraction device.

22. A card reuse method in a casino, in which a plurality of game tables is installed, to collect playing cards not used in the plurality of game tables and taking the playing cards to a backyard and to form, in the backyard, a new playing card set including playing cards of a predetermined number of decks to be reused in the game tables,
wherein each of the plurality of card shooters is assigned a shooter identification information to identify the card shooter and/or the playing card set to be loaded in the card shooter is assigned a set identification information, the card reuse method comprises:
collecting the plurality of unused playing cards from the plurality of card shooters used at each of the plurality of gaming tables and for drawing out playing card one by one;
extracting a plurality of playing cards of a predetermined number of decks from a plurality of unused playing cards collected in the collecting step;
shuffling the predetermined number of playing cards extracted in the extracting step;
forming the new playing card set with the predetermined number of playing cards shuffled in the shuffling step; and
managing the formation of the new playing card set, and
the card management step comprises:
acquiring information on the number of cards of the plurality of playing cards collected from each of the plurality of card shooters, as well as the shooter identification information of the card shooter that collected the plurality of playing cards and/or the set identification information of the plurality of playing cards that were collected; and
assigning set identification information for identifying the playing card set to a new playing card set newly formed by the forming step,
wherein the forming step is to load the new playing card set into a cartridge or card package, and the cartridge is loaded into the card shooter or the playing card set in the card package is loaded into the card shooter, so that the new playing card set is used on the game table.
